(19) United States
(12) Patent Application Publication
(10) Pub. No.: US 2013/0256100 A1
(43) Pub. Date: Oct. 3, 2013

(54) CONVEYOR BELT REPAIR TOOL

(71) Applicant: JOY MM DELAWARE, INC., Wilmington, DE (US)

(72) Inventors: James J. Melhuish, Franklin, PA (US); Brian C. Ziegler, Franklin, PA (US); Eugene F. Sebeck, Belleville, IL (US)

(73) Assignee: JOY MM DELAWARE, INC., Wilmington, DE (US)

(21) Appl. No.: 13/779,476

(22) Filed: Feb. 27, 2013

Related U.S. Application Data
(60) Provisional application No. 61/616,108, filed on Mar. 27, 2012.

(51) Int. Cl. F16G 3/08

(52) U.S. Cl. CPC F16G 3/08
USPC 198/844.2

(57) ABSTRACT

A repair tool for a conveyor belt includes a pair of clamps and a clamp coupling member extending between the pair of clamps. At least one clamp includes a first leg, a second leg, and a coupling member extending between the first and second legs. Each leg includes a clamping end portion for clamping the conveyor belt, and the clamping end portions define a belt-clamping channel therebetween. The coupling member urges the clamping end portions together.

### CROSS-REFERENCE TO RELATED APPLICATIONS

This application claims the benefit of U.S. Provisional Application No. 61/616,108, filed Mar. 27, 2012, the entire contents of which are hereby incorporated by reference.

### BACKGROUND

In underground mining, it is typical to employ a conveyor to haul or convey crushed ore out of a mine. The conveyor belt is typically made of a flexible elastomer. Through continued use, the conveyor belt may become worn and potentially torn adjacent its side peripheries. In case of a belt tear, one or more plate-shaped fasteners may be coupled to the conveyor belt across the torn portion to suitably hold the belt together and prevent the tear from propagating further.

### SUMMARY

In some embodiments, a repair tool for a conveyor belt includes a pair of clamps and a clamp coupling member extending between the pair of clamps. At least one clamp includes a first leg, a second leg, and a coupling member extending between the first and second legs. Each leg includes a clamping end portion for clamping the conveyor belt, and the clamping end portions define a belt-clamping channel therebetween. The coupling member urges the clamping end portions together.

In other embodiments, a repair tool for a conveyor belt includes a pair of clamps and a clamp coupling member extending between the pair of clamps. At least one clamp includes a first leg, a second leg, and a leg coupling member extending between the first and second legs. Each leg includes a clamping end portion for clamping the conveyor belt, a coupling end portion positioned away from the clamping end portion, and an intermediate angled portion extending therebetween. The clamping end portions define a belt-clamping channel therebetween. The coupling member connects the coupling ends of the first and second legs, and urges the clamping end portions together.

Other aspects of the invention will become apparent by consideration of the detailed description and accompanying drawings.

### BRIEF DESCRIPTION OF THE DRAWINGS

FIG. 1 is a perspective view of a torn conveyor belt repaired with fasteners.

FIG. 2 is an enlarged perspective view of the fastener of FIG. 1.

FIG. 3 is a perspective view of a repair tool according to one embodiment of the invention, illustrating the repair tool coupled to a torn conveyor belt.

FIG. 4 is an enlarged perspective view of the repair tool of FIG. 3, illustrating the repair tool coupled to the torn conveyor belt.

FIG. 5 is a top perspective view of the repair tool of FIG. 3.

FIG. 6 is an enlarged partial side perspective view of the repair tool of FIG. 3, illustrating a clamp.

FIG. 7 is a side view of the clamp of the repair tool of FIG. 6.

FIG. 8 is an end view of the clamp of the repair tool of FIG. 6.

It should be understood that the invention is not limited in its application to the details of construction and the arrangements of the components set forth in the following description or illustrated in the above-described drawings. The invention is capable of other embodiments and of being practiced or being carried out in various ways. Also, it is to be understood that the phraseology and terminology used herein is for the purpose of description and should not be regarded as limiting.

### DETAILED DESCRIPTION

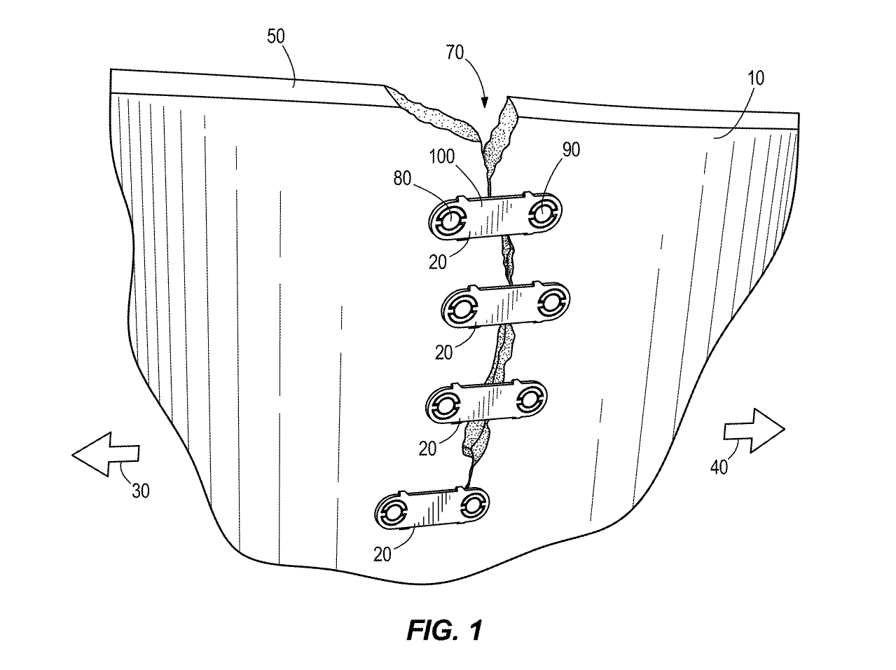

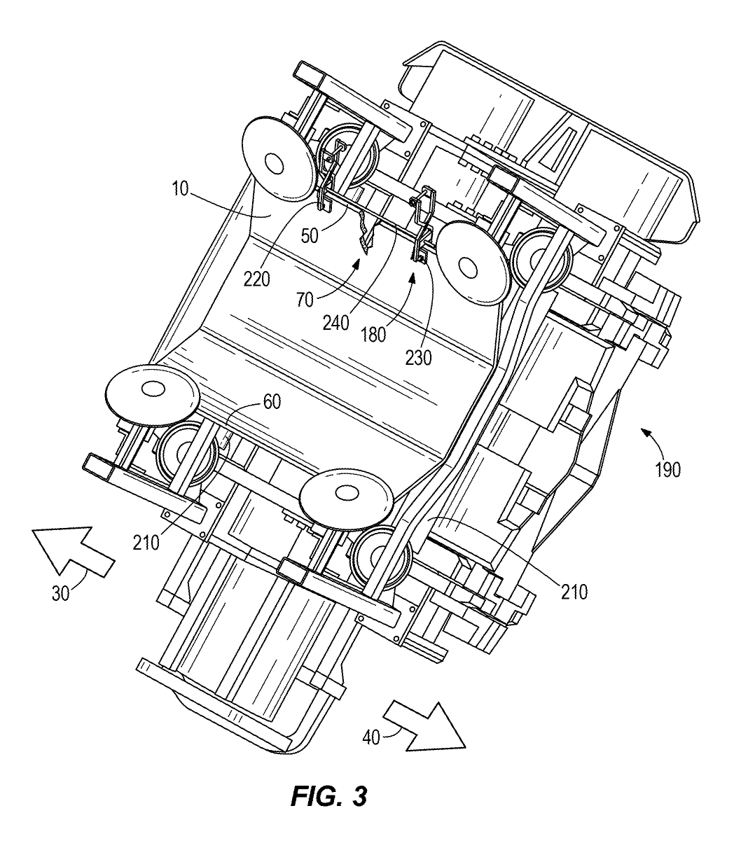

FIG. 1 is a perspective view of a torn conveyor belt 10 repaired with fasteners 20. The conveyor belt 10 is typically made of a flexible elastomer, and tensioned toward longitudinal directions 30 and 40 when in use. Through continued use, the belt 10 may become worn and potentially torn adjacent its side peripheries 50, 60 (only one side periphery 50 is shown in FIG. 1, side periphery 60 is shown in FIG. 3). In case of a belt tear, one or more plate-shaped fasteners 20 are coupled to the conveyor belt 10 across a torn portion 70 to suitably hold the belt 10 together and prevent the tear 70 from propagating further. The fastener 20 is a plate-shaped metal clip. When coupled to the conveyor belt 10, an outer surface of the fastener 20 is substantially flush with the belt 10. Although FIG. 1 illustrates the fastener 20 as coupled to the belt 10 by bolts 80, 90, the fastener 20 may be coupled to the belt 10 using other suitable mechanisms that may not require a bolt.

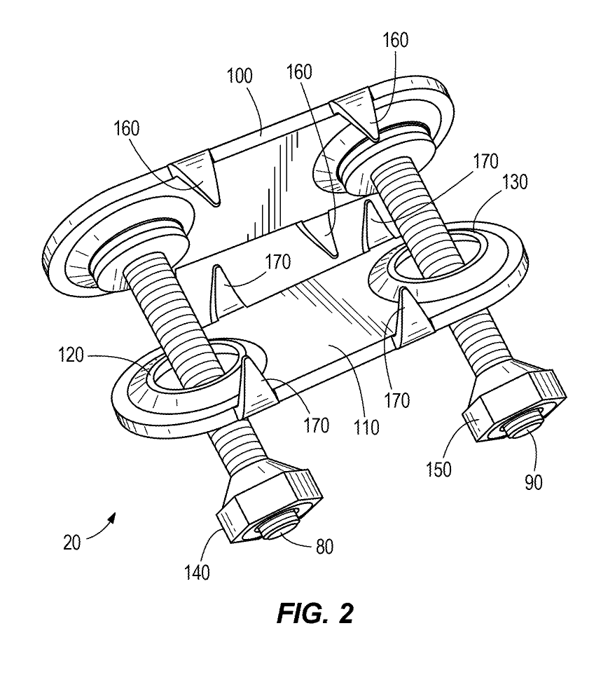

Referring also to FIG. 2, the illustrated fastener 20 includes the first bolt 80, the second bolt 90, a top plate 100 extending between the first and second bolts 80, 90, and a bottom plate 110 with openings 120, 130 that receive the first and second bolts 80, 90 respectively. As used herein, the terms “top,” “bottom,” “front,” “rear,” “side,” and other directional terms are not intended to require any particular orientation, but are instead used for purposes of description only. The top and bottom plates 100, 110 retain the torn portion 70 of the belt 10 therebetween and are urged together by nuts 140, 150. As shown in FIG. 2, the top and bottom plates 100, 110 each include teeth 160, 170, respectively, which are adapted to suitably penetrate the belt 10 when the fastener 20 is coupled to the belt 10, so as to facilitate retaining the belt 10. The fastener 20 can be formed of metal; however, the fastener 20 may also be molded or formed from any suitable plastic such as nylon, or made in other manners from other materials.

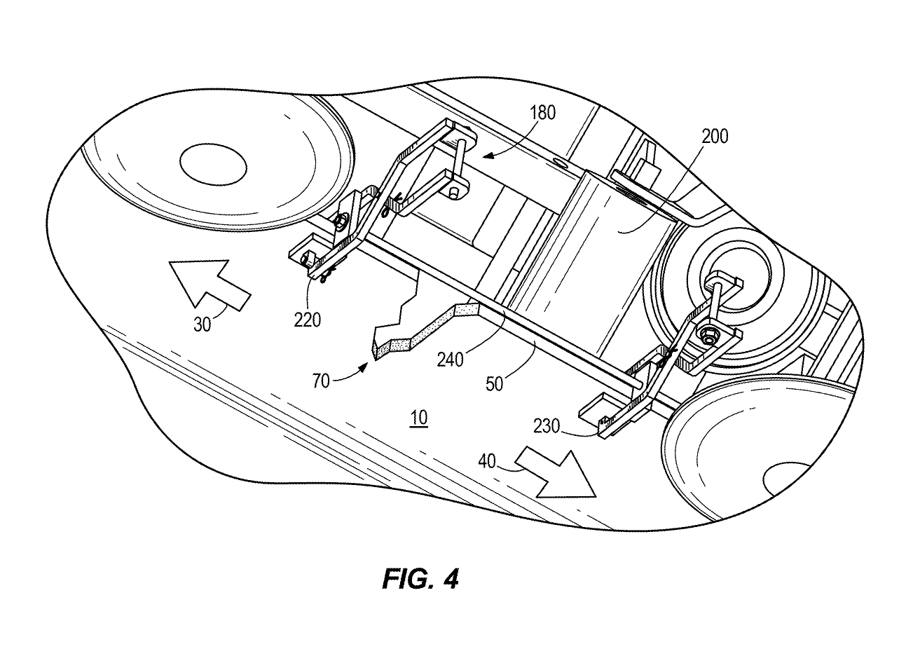

FIGS. 3 and 4 illustrate a repair tool 180 according to one embodiment of the invention for use with a conveyor 190. The illustrated conveyor 190 is a trough conveyor and includes a set of trough rollers 200 (FIG. 4) that support a conveying run of the conveyor belt 10, and a set of lower rollers 210 (FIG. 3) that support a return run of the conveyor belt 10. The illustrated belt 10 has a tear 70 adjacent the side periphery 50. As described above, fasteners 20 are typically placed across the tear 70 to repair the belt. The longitudinal tension applied to the belt 10, however, may facilitate undesirably propagating the tear 70 before the fasteners 20 are coupled to the belt 10. As a result, coupling the fasteners 20 to the belt 10 at desired locations can be time-consuming and cumbersome. For example, a fastener 20 may need to be applied first near a root of the tear 70, and then more fasteners 20 may need to be applied sequentially toward the side periphery 50 of the belt 10.

To facilitate an expedient and easy repair of the belt 10, the tool 180 includes a first clamp 220, a second clamp 230, and a clamp coupling member 240 extending between the first and second clamps 220, 230. In use, the clamps 220, 230 of the tool 180 are coupled to portions left and right of the tear 70, respectively. Thus, the tool 180 can counteract the longitudinal tension of the belt 10 and prevent further propagation of the tear 70 before the fasteners 20 are applied to the belt 10.

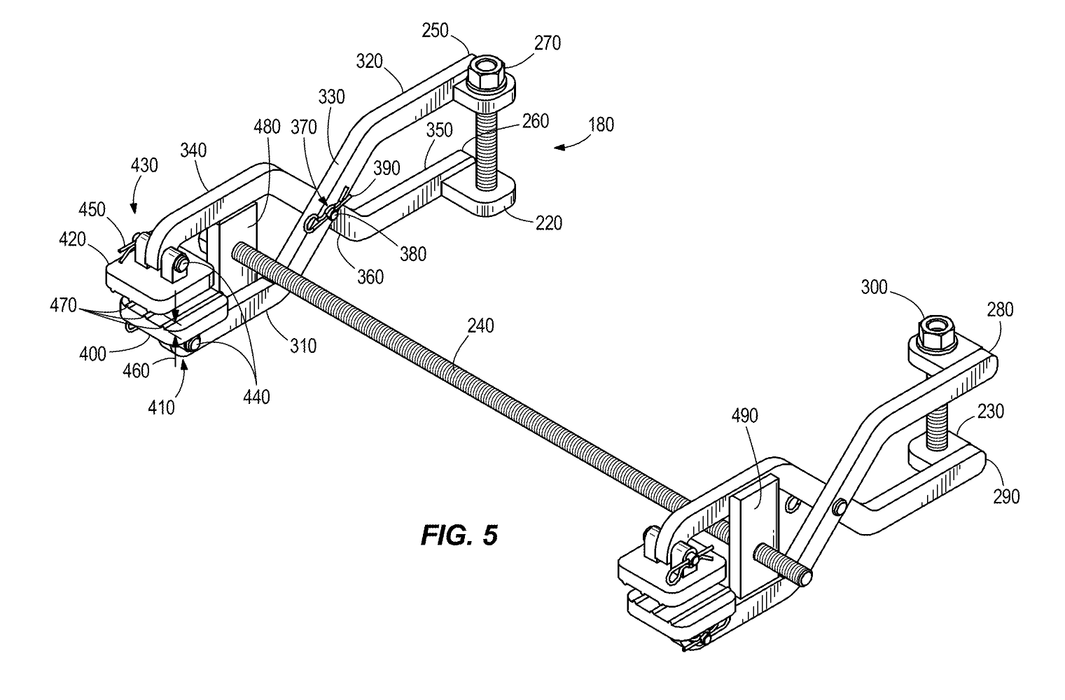

Referring to FIG. 5, the first clamp 220 of the tool 170 includes a first leg 250, a second leg 260, and a leg coupling member 270 that urges the first and second legs 250, 260 together. Likewise, the second clamp 230 includes a first leg 280, a second leg 290, and a leg coupling member 300 that urges the first and second legs 280, 290 together. For the purposes of the description, the configuration of the first and second clamps 220, 230 is generally the same, and will be described with reference to the first clamp 220 with the same effect as to the second clamp 230.

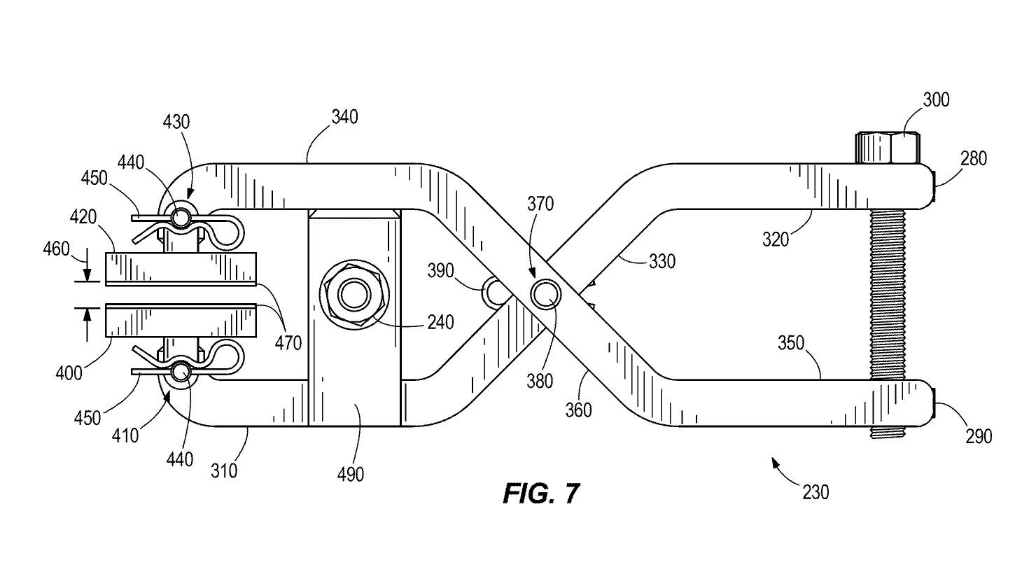

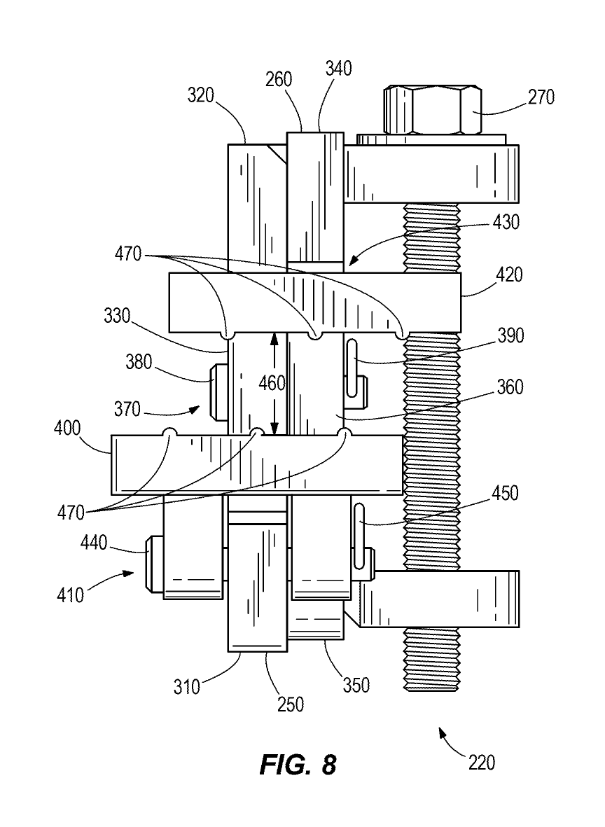

As illustrated in FIGS. 5-8, the first leg 250 of the first clamp 220 includes a clamping end portion 310 and a coupling end portion 320 positioned away from the clamping end portion 310. The clamping and coupling end portions 310, 320 are substantially parallel to each other. An intermediate angled portion 330 connects or extends between the two end portions 310, 320 so that the end portions 310, 320 are offset from each other in elevation. Likewise, the second leg 260 includes a clamping end portion 340 and a coupling end portion 350 positioned away from the clamping end portion 340. The clamping and coupling end portions 340, 350 are substantially parallel to each other. An intermediate angled portion 360 connects or extends between the two end portions 340, 350 so that the end portions 340, 350 are offset from each other in elevation. The intermediate portions 330, 360 of the first and second legs 250, 260 are coupled together at a hinge 370 so that the coupled portion resembles an X-shape. In the illustrated embodiment, the hinge 370 includes a shaft 380 having a pinhole and an R-shaped clip 390 that is insertable through the pinhole. In other embodiments, however, the intermediate portions 330, 360 of the first and second legs 280, 290, respectively, may be coupled to each other using other suitable mechanisms.

In the illustrated embodiment, the leg coupling member 270 of the first clamp 220 is a bolt that extends offset from the hinge 370 opposite the clamping end portions 310, 340 of the first and second legs 280, 290, coupling the coupling end portions 320, 350. The bolt 270 can be turned in a clockwise or counter-clockwise direction when viewed from above. That is, the clamp coupling member 240 defines a longitudinal axis, and the clamp coupling member or bolt 270 of the first clamp 220 is rotatable about an axis substantially perpendicular to the longitudinal axis. The clamping end portions 310, 340 of the first and second legs 250, 260 are configured to be urged together when the leg coupling member or bolt 270 is rotated about the respective axis. In other embodiments, however, the leg coupling member 270 may be a ratchet that is rotatable in only one direction.

In the illustrated embodiment, the coupling end portions 320, 350 of the first and second legs 250, 260 define a gap therebetween. The leg coupling member 270 is configured to expand the gap, and the clamping end portions 310, 340 of the first and second legs 250, 260 are configured to be urged together when the leg coupling member 270 expands the gap. That is, rotating the leg coupling member 270 to expand the offset distance between the coupling end portions 320, 350 urges the opposite clamping end portions 310, 340 together. In this sense, the hinge 370 acts as a fulcrum.

In the illustrated embodiment, the clamping end portion 310 of the first leg 280 is coupled to a first platen or substantially planar member 400 at a first hinge 410. Likewise, the clamping end portion 340 of the second leg 290 is coupled to a second platen or substantially planar member 420 at a second hinge 430. In the illustrated embodiment, the first and second hinges 410, 430 each include a respective shaft 440, which has a pinhole and a respective R-shaped clip 450 that is insertable through the pinhole for coupling the platen to the shaft 440. In other embodiments, however, the first and second platens 400, 420 may be coupled to the respective end portions 310, 340 using other suitable mechanism. In the illustrated embodiment, the first and second platens 400, 420 of the first and second legs 250, 260 define a belt-clamping channel 460 therebetween. The belt 10 is received in the channel 460 and clamped by the first and second platens 400, 420 when the clamping end portions 310, 340 of the first and second legs 280, 290 are urged together. In the illustrated embodiment, the first and second platens 400, 420 each include ribs or raised portions 470 that may facilitate clamping the belt 10 tightly.

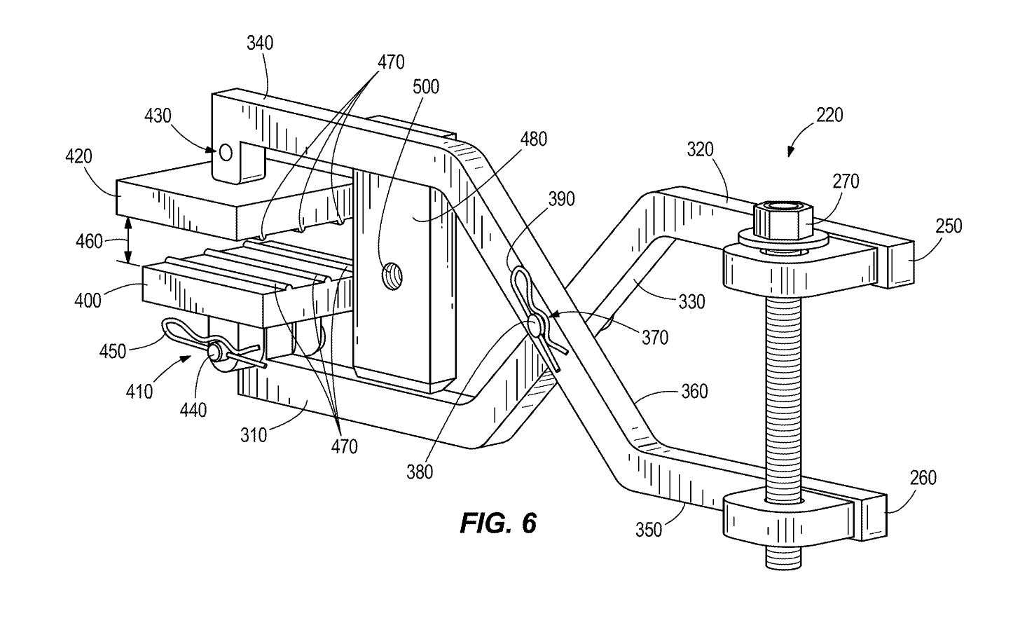

Referring again to FIG. 5, the first and second clamps 220, 230 are coupled together through the clamp coupling member 240. In the illustrated embodiment, each of the clamps 220, 230 includes a respective support member 480, 490. Each support member 480, 490 includes an opening 500 (FIG. 6) therethrough, and receives the clamp coupling member 240 through the respective opening 500. In the illustrated embodiment, the clamp coupling member 240 is a bolt. By rotating the clamp coupling member 240, the length between the first and second clamps 220, 230 can be adjusted. In other embodiments, however, the first and second clamps 220, 230 may be coupled using other suitable mechanism that may not require a bolt. In still other embodiments, the length between the first and second clamps 220, 230 may be fixed.

Although the invention has been described in detail with reference to certain preferred embodiments, variations and modifications exist within the scope and spirit of one or more independent aspects of the invention as described.

What is claimed is:

1. A repair tool for a conveyor belt, the repair tool comprising:
a pair of clamps, at least one clamp including a first leg, a second leg, and a coupling member extending between the first and second legs, wherein each leg includes a clamping end portion for clamping the conveyor belt and the clamping end portions define a belt-clamping channel therebetween, and further wherein the coupling member urges the clamping end portions together; and
a clamp coupling member extending between the pair of clamps.

2. The repair tool of claim 1, wherein each of the first and second legs includes a coupling end portion positioned away from the clamping end portion, and wherein the coupling member of each clamp connects the coupling ends of the first and second legs.

3. The repair tool of claim 2, wherein the clamp coupling member defines a longitudinal axis, wherein each coupling member is rotatable about a respective axis substantially perpendicular to the longitudinal axis, and wherein the clamping end portions of each leg are urged together when the coupling member is rotated about the respective axis.

4. The repair tool of claim 2, wherein each of the first and second legs includes an intermediate angled portion extending between the clamping and coupling end portions.

5. The repair tool of claim 4, wherein the intermediate angled portions of the first and second legs are hingedly coupled together.

6. The repair tool of claim 4, wherein the coupling end portions of each leg define a gap therebetween, wherein the coupling member is configured to expand the gap, and wherein the clamping end portions are urged together when the coupling member expands the gap.

7. The repair tool of claim 1, wherein at least one of the clamps includes a substantially planar member coupled to each clamping end portion of the first and second legs.

8. The repair tool of claim 7, wherein each substantially planar member is hingedly coupled to the respective clamping end portion.

9. The repair tool of claim 7, wherein the belt-clamping channel extends between the substantially planar members of the first and second legs.

10. The repair tool of claim 7, wherein at least one of the substantially planar member includes at least one raised portion.

11. The repair tool of claim 1, wherein each clamp includes a respective support member with an opening therethrough, and the clamp coupling member is insertable through at least a portion of each opening.

12. The repair tool of claim 1, wherein the pair of clamps are substantially identical.

13. A repair tool for a conveyor belt, the repair tool comprising:
a pair of clamps, at least one clamp including a first leg, a second leg, and a coupling member extending between the first and second legs, wherein each leg includes a clamping end portion for clamping the conveyor belt, a coupling end portion positioned away from the clamping end portion, and an intermediate angled portion extending therebetween, wherein the clamping end portions define a belt-clamping channel therebetween, and further wherein the coupling member connects the coupling ends of the first and second legs, and urges the clamping end portions together; and
a clamp coupling member extending between the pair of clamps.

14. The repair tool of claim 13, wherein the clamp coupling member defines a longitudinal axis, wherein each coupling member is rotatable about a respective axis substantially perpendicular to the longitudinal axis, and wherein the clamping end portions of each leg are be urged together when the coupling member is rotated about the respective axis.

15. The repair tool of claim 13, wherein the intermediate angled portions of the first and second legs are hingedly coupled together.

16. The repair tool of claim 13, wherein the coupling end portions of each leg define a gap therebetween, wherein the coupling member is configured to expand the gap, and wherein the clamping end portions are urged together when the coupling member expands the gap.

17. The repair tool of claim 13, wherein at least one of the clamps includes a substantially planar member coupled to each clamping end portion of the first and second legs.

18. The repair tool of claim 17, wherein each substantially planar member is hingedly coupled to the respective clamping end portion.

19. The repair tool of claim 17, wherein the belt-clamping channel extends between the substantially planar members of the first and second legs.

20. The repair tool of claim 17, wherein at least one of the substantially planar member includes at least one raised portion.

21. The repair tool of claim 13, wherein each clamp includes a respective support member with an opening therethrough, and the clamp coupling member is insertable through at least a portion of each opening.

22. The repair tool of claim 13, wherein the pair of clamps are substantially identical.
